(19) United States
(12) Patent Application Publication
(10) Pub. No.: US 2006/0071941 A1
(43) Pub. Date: Apr. 6, 2006

(54) Method of video clipping prevention in color non-uniformity correction systems

(75) Inventor: Michael Bakhmutsky, Spring Valley, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/539,978

(22) PCT Filed: Dec. 11, 2003
(86) PCT No.: PCT/IB03/05906

§ 371 Date: Jun. 19, 2005

Related U.S. Application Data
(60) Provisional application No. 60/434,588, filed on Dec. 18, 2002.

(51) Int. Cl. G09G 5/00

(52) U.S. Cl. 345/606

(57) ABSTRACT

A method and apparatus for correcting a video signal includes providing a comparison of correction data to safety margin data, and determining a level of correction based on this comparing, wherein video correction is provided, but clipping of the video signal is substantially prevented.

The present invention relates generally to video processing for color displays, and in particular to a method and apparatus for providing color non-uniformity correction in color displays, including liquid crystal (LC) color displays.

Color displays are used in a variety of electronic devices. These include monitors for personal computers, televisions, and other video displays. These displays may be direct-view, cathode-ray tube devices, or projection devices.

One type of projection device is based on the optical properties of liquid crystals, such as nematic crystals. These projection devices may include a layer of liquid crystal disposed over a semiconductor transistor array. Often, the array is one of complementary metal-oxide-semiconductor (CMOS) transistors that are used to selectively produce electric fields across the layer of liquid crystal. These electric fields change the polarization angle of the liquid crystal material molecules enabling the modulation of light that traverses this material. The light may be reflected by reflective elements or may be transmitted to the screen. In either case, the modulated light is projected onto a screen by optical elements forming a video image. In case of reflection, projection devices are referred to as liquid crystal on semiconductor (LCOS) projection displays.

Some factors that impact image quality of displays are resolution, brightness, contrast, and color depth. Resolution is the number of pixels a screen displays. Often, the resolution is expressed in a particular pixel dimension (e.g. 800×600 for many computer monitors). In this example, the monitor has 800 pixels in the horizontal dimension, and 600 pixels in the vertical dimension. Of course, the greater the number of pixels for a given display area, the smaller area of each pixel is, and the greater the resolution.

Color depth defines how many colors can be displayed on a screen. Generally, color depth is described in binary logic (bits). Each of the three primary colors used in color displays (red, blue, green) has a number of bits that describes its color depth, or the number of shades of a particular color that may be displayed. The number of colors is normally described via binary exponential notation (e.g., 2⁸ (referred to as 8 bit video) for 256 shades of each of the three primary colors). As can be readily appreciated, the greater the number of color bits, the greater the number of shades of the color, and the greater the color depth. Of course, the greater the color depth, the better is the display quality.

While the resolution, brightness, contrast, and color depth may be chosen for a particular desired image quality, certain factors may deteriorate the image quality. For example, non-uniformities of electronic and optical sources in LCOS projection devices can have deleterious effects on the quality of the projected image.

What is needed is a correction method and apparatus, which overcomes certain drawbacks of known correction schemes, such as video clipping.

In accordance with an exemplary embodiment of the present invention, a method of correcting a video signal comprises providing a comparison of correction data to safety margin data, and determining a level of correction based on this comparing, wherein video correction is provided, but clipping of the video signal is substantially prevented.

Another embodiment of the present invention is drawn to an apparatus for correcting a video signal that comprises a correction data interpolator, which interpolates correction data, and a safety margin interpolator, which interpolates safety margin data. The comparison of the correction data with the safety margin data also enables a determination of a level of video correction, wherein suitable video correction is provided, but video signal clipping is substantially prevented.

The invention is best understood from the following detailed description when read with the accompanying drawing figures. It is emphasized that the various features are not necessarily drawn to scale. In fact, the dimensions may be arbitrarily increased or decreased for clarity of discussion.

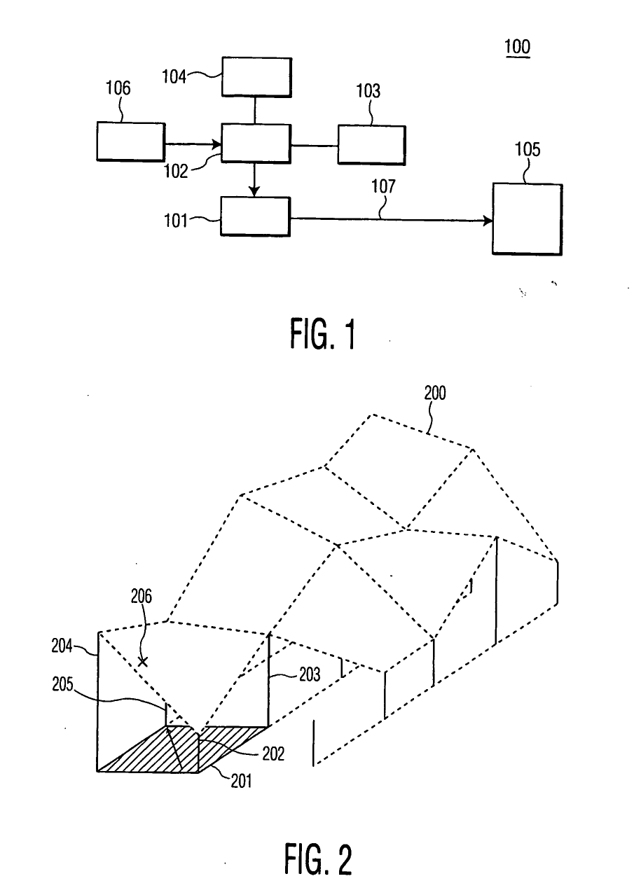

FIG. 1 is a perspective view of a video correction apparatus in accordance with an exemplary embodiment of the present invention.

FIG. 2 is an illustration of bilinear interpolation of correction data in accordance with an exemplary embodiment of the present invention.

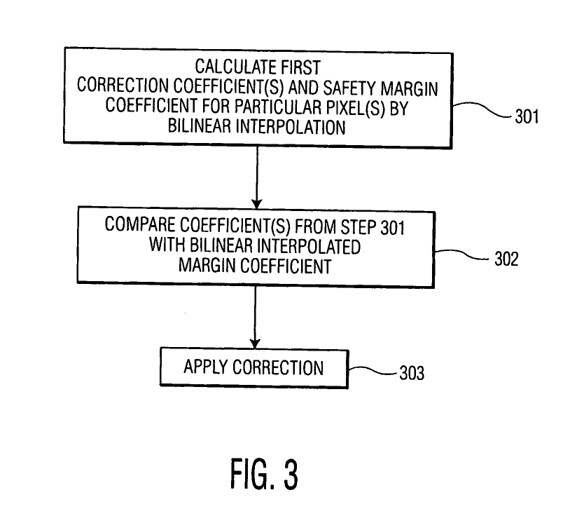

FIG. 3 is a flow chart of a correction method that substantially avoids clipping in accordance with an exemplary embodiment of the present invention.

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to a method and apparatus for providing color non-uniformity correction in real-time by applying correction data to the video signal, which both provide suitable correction of the non-uniformity and substantially prevent clipping of the video signal. The correction for the LCD panel non-uniformity is effected electronically by a bilinear interpolation technique that does not require the storage of all of the correction data for all the pixels of all the colors in a memory. This bilinear interpolation technique is used to determine both the correction coefficients, which compensate for color non-uniformity and the video modification safety margin data, which limit the range of video modification so that the video clipping phenomena resulting from correction is substantially eliminated.

As will become clearer as the present description continues, the method and apparatus of an exemplary embodiment includes a comparison of the correction data for each pixel to the safety margin data to avoid clipping of the video signal. If the interpolated correction coefficient exceeds an interpolated safety margin value, a level of correction is carefully reduced to provide color non-uniformity correction, while substantially avoiding video signal clipping.

FIG. 1 shows an LCD apparatus 100 in accordance with an exemplary embodiment. A correction safety margin device 104, based on the video levels of a block of pixels, illustratively computes an absolute minimum video modification safety margin out of the multitude of its pixel's safety margin minimums of video modification in both the positive (enhancement) and negative (reduction) directions of correction. These data are further spatially interpolated in a correction device 102 to provide a gracefully changing limiting function for interpolated correction data.

A correction coefficient device 103 essentially is a memory for a highly decimated correction data that is applied to the correction device 102, which interpolates this data spatially.

An LCD device 101 transmits an optical video signal 107, via optics (not shown) to an image display screen 105. The LCD device 101 is connected to a correction device 102, which provides the electronic correction of video non-uniformity due to LCD panel non-uniformity. The LCD device also receives a video signal from the video input 106. For each pixel of the LCD panel, and therefore image display screen 105, the respective outputs of a correction coefficient device 103, and a safety margin device 104 are input to the correction device 102. The correction device 102 interpolates both correction and safety margin data, compares these data, and based on this comparison, produces a modified correction coefficient, which is applied to the video and further, to the LCD device 101 for the given pixel of the LCD panel. This modified correction coefficient applies suitable correction for color non-uniformity, while gracefully preventing video signal clipping.

In accordance with an exemplary embodiment, both the correction coefficients of the correction coefficient device 103 and the safety margin data of the safety margin device 104 are calculated for each video pixel using a bilinear interpolation technique that is described in further detail herein. It is noted that the bilinear interpolation technique referenced is merely illustrative, and other two-dimensional interpolation techniques may be used.

The correction device 102 includes the required elements to effect the calculation of the correction data (e.g., an interpolator) and to alter the video level at each pixel in order control the LCD as needed. As will become clearer as the present description continues, video non-uniformity with the correction device 102 is effected to provide a gracefully limited correction with no video clipping, and therefore, higher quality image at the image display screen.

In general, the correction device 102 provides electronic color correction by video modification. In order to achieve this correction, the brightness distributions for each pixel at a number of video levels are evaluated individually for each color path. As can be appreciated, in order to save memory, not every pixel of the LCD panel is evaluated. Rather, a limited number of pixels located at a grid of points are evaluated. The points of the grid are spaced with respect to each other by a predetermined number of pixels both vertically and horizontally, and form an interpolation block. In the process of calibration, differences between the actual and the anticipated video-based brightness levels for the particular video levels under evaluation are calculated and are stored as correction coefficients (one data per a block of pixels in small memories) in the correction coefficient device 103. These stored data are then interpolated via the correction device 102 in order to derive the correction coefficients for any x, y pixel coordinate of within the interpolation block.

FIG. 2 shows conceptual view of a bilinear interpolation scheme in accordance with an exemplary embodiment of the present invention. The interpolation block 201 includes four measured and stored coefficients (202, 203, 204 and 205), which are illustratively the correction coefficients. The correction coefficient (e.g. interpolated coefficient 206) for any interpolated point on a map of correction data 200 (e.g., interpolated point 205) is illustratively determined by the correction device 102 by a technique described in U.S. patent application Ser. No. 10/179,319, entitled “Color Non-Uniformity Correction Method and Apparatus,” to Michael Bhatmustsky, and filed on Jun. 24, 2002. The disclosure of this application is incorporated herein and for all purposes.

However, the calculated video correction, when added to the video signal can cause the video to exceed its maximum allowable level, which will result in clipping of the video signal. For example, consider 255-level video. If the video level of a particular pixel is at 190, and the correction coefficient is determined to be 100, applying this level of correction exceed the maximum video level of 255. The video signal will be clipped, which causes unacceptable artifacts on the image display screen 105.

In accordance with an exemplary embodiment of the present invention, the safety margin device 104 determines, for each video pixel, the maximum level of correction that may be applied so that video clipping is avoided. However, rather than store the absolute minimum of safety margins for a block of pixels, these data are computed in the safety margin device 104.

Furthermore the bilinear (or other spatial) interpolation technique described above is used to derive the safety margin for each pixel as a smooth changing spatial function. Illustratively, each pixel has a maximum level of video correction, which is equal to its magnitude in the direction of video reduction, or to its maximum value (e.g., 255 for 8-bit video) minus the actual video magnitude if the correction is in the direction of enhancement. The minimum of these two values assigned to a pixel based on its current video level will determine the safe and conservative video modification range that, if not exceeded, will not produce any clipping. Rather than store the safety margin data for each pixel, these data may be computed. For example, an absolute minimum of the individual dynamic ranges described above may be computed for a representative number of pixels in each interpolation block (e.g., interpolation block 201), and stored as one data element for each block. By employing these minimum margins for the representative pixel blocks, one is certain not to exceed an allowed video modification, thereby preventing video clipping. It is noted that the safety margin data are determined from the video signals in real-time and are interpolated in the correction device 102.

Once these safety margin data are gathered and stored for each interpolation pixel block of the LCD display, bilinear interpolation is used to determine the safety margin data for any pixel of any interpolation block across the video picture. These data are determined in the safety margin device 104, and are fed into the correction device 102, where the interpolation is performed along with the comparison of these data with the interpolated correction coefficient data retrieved from a the correction coefficient device 103, so that the gracefully limited correction for color non-uniformity may be performed.

To provide a high-quality correction, the color correction data of device 103 are obtained for a variety of color levels. In an exemplary embodiment, four correction data for each interpolation block are stored in a memory device in the devices 103 in such a manner that they can be substantially simultaneously available. These data are spatially interpolated within a pixel block. Similarly, the safety margin data are spatially interpolated within the same pixel block. To effect color correction across the image screen, and without video signal clipping, a plurality of the color correction data and safety margin data representative of all pixel locations of the display are derived for combined processing.

FIG. 3 is a flowchart of an exemplary method of correcting for video non-uniformity, while substantially preventing clipping of the video signal. The correction coefficients and safety margin data are obtained for each pixel of the display as described above. Next, as shown at step 301, the correction coefficient(s) (data) and safety margin data for one or more pixels are computed by means of interpolation. These computations are carried out via the correction coefficient device 103, safety margin data device 104 and correction device 102, which effects the interpolation as discussed herein. After both types of data (i.e., correction coefficient and safety margin) are computed by means of interpolation in the correction device, they are compared at step 302 of the exemplary method. The comparison is also effected for example via the correction device 102.

At step 303, if the correction coefficient is less than or equal to the corresponding interpolated safety margin, the correction coefficient will be applied to the video to correct color non-uniformity in a manner similar to that described in the referenced patent application to M. Bakhmutsky. If the correction coefficient exceeds the safety margin, a reduced correction coefficient, generally equal to the correction margin is applied at step 303. As such, because the safety margin for clipping is never exceeded, video clipping is substantially avoided, while the color non-uniformity correction is effected.

It is noted that the comparative sequence of the exemplary method of FIG. 3 may be effected in manufacturing, or may be effected in a deployed device To this end, in the former case, it may provide a quality assurance and improved yield capability during manufacture. In other words, the process may be potentially used to disqualify the particular LCD panel as failing quality control. This technique may ensure that a deployed product provides a high degree of image quality by the prevention of artifacts on the image via the substantial avoidance of video signal clipping.

Finally, it is noted that while the exemplary embodiments thus far described have clear advantages, there are variations to the described method and apparatus that can be made. For example, in the exemplary embodiments thus far described, the safety margin data have a magnitude corresponding to the absolute minimum dynamic range for a sampled pixel of a particular interpolation block. However, it is noted that two types of safety margin data could be assigned (computed) for each sampled pixel, one for enhancement, and one for reduction. These data can be interpolated separately and used selectively to limit the video modification based on the direction (sign) of correction (up or down).

The invention being thus described, it would be obvious that the same may be varied in many ways by one of ordinary skill in the art having had the benefit of the present disclosure. Such variations are not regarded as a departure from the spirit and scope of the invention, and such modifications as would be obvious to one skilled in the art are intended to be included within the scope of the following claims and their legal equivalents.

1. A method of correcting a video signal, the method comprising: providing a plurality of correction data;
comparing the correction data to safety margin data; and
determining a level of correction based on the comparing, wherein correction of video non-uniformity is provided, but clipping of the video signal is substantially prevented.

2. A method as recited in claim 1, wherein the providing of the correction data comprises interpolating the correction data using a two-dimensional interpolation technique.

3. A method as recited in claim 1, wherein the method includes providing said safety margin data by interpolating stored safety margin data.

4. A method as recited in claim 1, wherein said correction of video comprises, based on said comparing, applying a particular level of video correction.

5. A method as recited in claim 4, wherein said particular level of video correction is less than or equal to an absolute an absolute minimum video modification safety margin value.

6. A method as recited in claim 2, further comprising evaluating a limited number of pixels of an LCD to determine said correction data for a particular interpolation block.

7. A method as recited in claim 3, further comprising evaluating a limited number of pixels of an LCD to determine said safety margin data for a particular interpolation block.

8. A method as recited in claim 3, wherein said interpolating is a two-dimensional interpolation technique.

9. An apparatus for correcting a video signal comprising:
a correction device, which compares correction data with safety margin data to determine a level of video correction based in the comparison, wherein video correction is provided, but video signal clipping is substantially prevented.

10. An apparatus as recited in claim 9, further comprising a safety margin device, which stores said safety margin data, and a correction coefficient device, which stores said correction data.

11. An apparatus as recited in claim 10, wherein said safety margin device and said correction coefficient device are each input to said correction device, which provides interpolated correction data and interpolated margin safety data based on input from said correction data device and said margin safety device, respectively.

12. An apparatus as recited in claim 11, wherein said comparing is performed using said interpolated correction data and interpolated margin safety data.

13. An apparatus as recited in claim 1, wherein said correction device applies said level of video correction to an LCD, and said level is less than or equal to an absolute minimum video modification safety margin.

14. An apparatus as recited in claim 10, wherein said stored safety margin data is determined by evaluating a limited number of pixels of an LCD.

15. An apparatus as recited in claim 11, wherein said interpolated correction data is determined using a two-dimensional interpolation technique.

16. An apparatus as recited in claim 15, wherein said two-dimensional interpolation technique is a bi-linear interpolation technique.

17. An apparatus as recited in claim 11, wherein said interpolated margin safety data determined using a two-dimensional interpolation technique.

18. An apparatus as recited in claim 17, wherein said two-dimensional interpolation technique is a bi-linear interpolation technique.
